(19) United States
(12) Patent Application Publication
(10) Pub. No.: US 2009/0301477 A1
(43) Pub. Date: Dec. 10, 2009

(54) HEAT AND MOISTURE EXCHANGE UNIT WITH CHECK VALVE

(76) Inventors: Brian William Pierro, Yorba Linda, CA (US); Khalid Said Mansour, Riverside, CA (US); Neil Alex Korneff, Diamond Bar, CA (US)

Correspondence Address: DICKE, BILLIG & CZAJA, PLLC;ATTN: CFN MATTERS, 100 SOUTH FIFTH STREET, SUITE 2250, MINNEAPOLIS, MN, 55402, US

(21) Appl. No.: 12/133,976

(22) Filed: Jun. 5, 2008

(51) Int. Cl. A62B 18/08

(52) U.S. Cl. 128/201.13

(57) ABSTRACT

An HME unit including a housing, an HM media, and a check valve assembly. The housing forms a first port, a second port, and an intermediate section defining first and second flow paths fluidly connecting the first and second ports. The HM media is maintained within the intermediate section along the second flow path. The check valve assembly includes an obstruction member movably positioned within the intermediate section to selectively provide opened and closed positions. In the opened position, the first flow path is open relative to the obstruction member. In the closed position, the obstruction member closes the first flow path. In one mode, the obstruction member transitions to the opened position in response to gas flow in a flow direction from the second port toward the first port, and transitions to the closed position in response to gas flow in an opposite flow direction.

### BACKGROUND

The present disclosure relates to a heat and moisture exchange (“HME”) unit useful with a patient breathing circuit. More particularly, the HME unit of the present disclosure is connectable to a breathing circuit and provides a check valve construction that promotes desired air flow patterns relative to a contained heat and moisture retaining media in HME and bypass modes of operation.

The use of ventilators and breathing circuits to assist in patient breathing is well known in the art. The ventilator and breathing circuit provide mechanical assistance to patients who are having difficulty breathing on their own. For example, during surgery and other medical procedures, the patient is often connected to a ventilator to provide respiratory gases to the patient. One disadvantage of such breathing circuits is that the delivered air does not have a humidity level and/or temperature appropriate for the patient's lungs.

In order to provide air with desired humidity and/or temperature to the patient, an HME unit can be fluidly connected to the breathing circuit. As a point of reference, “HME” is a generic term, and can include simple condenser humidifiers, hygroscopic condenser humidifiers, hydrophobic condenser humidifiers, etc. In general terms, HME units consist of a housing that contains a layer of heat and moisture retaining media or material (“HM media”). This material has the capacity to retain moisture and heat from the air that is exhaled from the patient's lungs, and then transfer the captured moisture and heat to the ventilator-provided air of an inhaled breath. The HM media can be formed of foam, paper, or other suitable material(s) that are untreated or treated, for example with hygroscopic material.

While the HME unit addresses the heat and humidity concerns associated with ventilator-provided air in a breathing circuit, other drawbacks may exist. For example, it is fairly common to introduce aerosolized medication particles into the breathing circuit (e.g., via a nebulizer) for delivery to the patient's lungs. Where an HME unit is present in the breathing circuit, however, the medication particles will not readily traverse through the HM media and thus not be delivered to the patient. In addition, the HM media can become clogged with the droplets of liquid medication, in some instances leading to an elevated resistance of the HME unit. One approach for addressing these concerns is to remove the HME unit from the breathing circuit when introducing aerosolized medication. This is time consuming and subject to errors, and can result in the loss of recruited lung volume when the circuit is depressurized. Alternatively, various HME units have been suggested that incorporate intricate bypass structures/valves that selectively and completely isolate the HM media from the airflow path. While viable, these and other bypass-type HME units may not provide sufficient warming or humidifying of the HM media during prolonged aerosol treatments and/or are relatively complex and thus expensive.

In light of the above, a need exists for improved HME units having HM media bypass feature(s) that addresses one or more of the problems associated with conventional bypass-type HME units.

### SUMMARY

Some aspects in accordance with the present disclosure relate to a heat and moisture exchange (HME) unit including a housing, a heat and moisture retaining media (HM media), and a check valve assembly. The housing forms a first port, a second port, and an intermediate section extending there between. In this regard, the intermediate section defines first and second flow paths fluidly connecting the first and second ports. The HM media is maintained within the intermediate section along the second flow path. The check valve assembly includes an obstruction member movably positioned within the intermediate section to selectively provide an opened position and a closed position. In the opened position, the first flow path is open relative to the obstruction member. In the closed position, the obstruction member closes the first flow path. With this in mind, the HME unit is configured to provide a first mode of operation in which the obstruction member transitions to the opened position in response to airflow in a flow direction from the second port toward the first port, and transitions to the closed position in response to airflow in a flow direction from the first port toward the second port. With this construction, the HME unit can be assembled to a patient ventilator circuit such that the first port is fluidly proximate the patient and the second port is fluidly proximate the ventilator. In the first or bypass mode of operation, airflow from the ventilator forces the check valve assembly to open, thereby permitting airflow to occur along the first flow path, thus avoiding the HM media. Conversely, airflow in a direction from the patient directs the obstruction member to the closed position, such that airflow is forced to the HM media. In some embodiments, the check valve assembly further includes a locking device for selectively locking the obstruction member in the closed position, for example in connection with an HME mode of operation. In other embodiments, the HME unit further includes a primary valve mechanism, apart from the check valve assembly, that further dictates airflow to, or away from, the HM media.

Other aspects in accordance with principles of the present disclosure relate to a method of providing respiratory treatment to a patient, and include providing an HME unit including a housing, an HM media, and a check valve assembly. The housing forms a ventilator-side port, a patient-side port, and an intermediate section extending between the ports. The intermediate section defines first and second flow paths fluidly connecting the ports. The HM media is maintained within the intermediate section along the second flow path, with the check valve assembly including an obstruction member movably positioned within the intermediate section. The ventilator-side port is connected to a source of pressurized gas, whereas the patient-side port is connected to a patient. The source of gas is then operated to deliver airflow to the HME unit. In this regard, the HME unit is operated in a first, bypass mode in which airflow entering the HME unit at the ventilator-side port causes the obstruction member to open the first flow path, whereas airflow entering the HME unit at the patient-side port causes the obstruction member to close the first flow path. In some embodiments, the HME unit further includes a primary valve mechanism, with the HME unit being operable in the bypass mode as well as an HME mode. In this regard, transitioning of the HME unit between the bypass and HME modes includes maneuvering the primary valve mechanism such as by a pivoting or rotational user actuation.

### BRIEF DESCRIPTION OF THE DRAWINGS

FIG. 1 is a simplified illustration of an example patient breathing circuit with which an HME unit in accordance with principles of the present disclosure is useful;

FIG. 2 is a simplified illustration of another example breathing circuit with which the HME unit in accordance with principles of the present disclosure is useful;

FIGS. 3 and 4 are simplified, perspective cutaway views illustrating portions of an HME unit in accordance with principles of the present disclosure;

FIG. 5 is an enlarged, perspective view of a portion of the HME unit of FIGS. 3 and 4, illustrating a check valve assembly component;

FIGS. 6A and 6B illustrate operation of the HME unit of FIGS. 3 and 4 in a bypass mode of operation;

FIG. 7 illustrates operation of the HME unit of FIGS. 3 and 4 in an HME mode of operation;

FIGS. 8 and 9 are perspective cutaway views illustrating portions of another HME unit in accordance with principles of the present disclosure;

FIGS. 10 and 11 are perspective cutaway views illustrating portions of another HME unit in accordance with principles of the present disclosure;

FIG. 12 is an expanded, perspective view of another HME unit in accordance with principles of the present disclosure; and

FIGS. 13A and 13B are cross-sectional views of the HME unit of FIG. 12 in various stages of operation.

### DETAILED DESCRIPTION

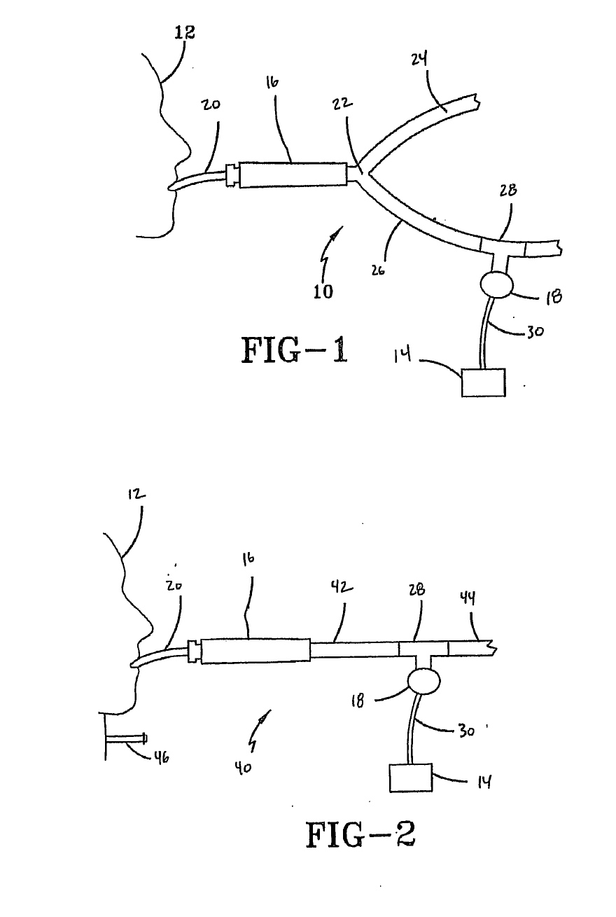

As described in detail below, aspects in accordance with principles of the present disclosure relate to an HME unit useful with a patient breathing circuit. As a point of reference, FIG. 1 illustrates one such breathing circuit 10 as including a number of flexible tubing segments that are connected in between a patient 12 and a ventilator (not shown). The breathing circuit 10 of FIG. 1 is a dual limb breathing circuit, and can include a source of pressurized air 14, an HME unit 16 (shown in block form) in accordance with the present disclosure, and a nebulizer 18.

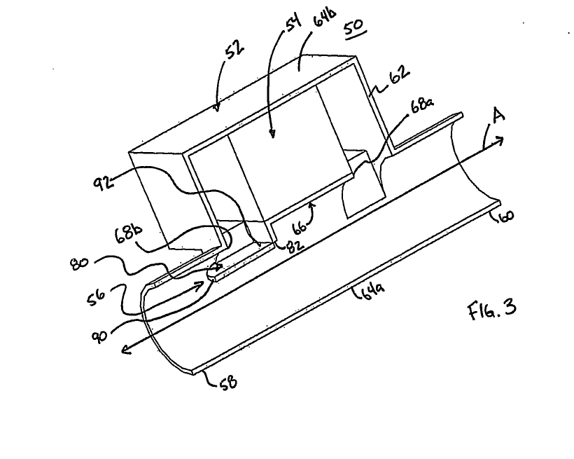

With the one, non-limiting example of the breathing circuit 10 in mind, a patient tube 20 is provided that connects the patient 12 to the HME unit 16. An end of the patient tube 20 that interfaces with the patient 12 can be an endotracheal tube that extends through the patient's mouth and throat and into the patient's lungs. Alternatively, it also may be connected to a tracheostomy tube (not shown in FIG. 1, but referenced at 46 in FIG. 2) that provides air to the patient's throat and thereby to the patient's lungs. Extending on an opposite side of the HME unit 16 is a connector 22, for example a Y-connector. The Y-connector 22 can be connected to additional tubing for example, an exhalation tube 24 (commonly referred to as the “exhalation limb”) that allows exhaled air to leave the breathing circuit 10. A second tube 26 (commonly referred to as the “inhalation limb”) can serve as a nebulizer tube, and is connected to the nebulizer 18. The nebulizer 18, in turn, is connected to the inhalation limb 26 via a connector 28, for example a T-connector. The T-connector 28 is connected at an end opposite the inhalation limb 26 to a ventilator (not shown). The nebulizer 18, in turn, is also connected to the source of pressurized air 14 via an air tube 30.

By way of further reference, FIG. 2 illustrates an alternative breathing circuit 40 with which the HME unit 16 of the present disclosure is useful. The breathing circuit 40 is a single limb breathing circuit that again serves to fluidly connect a ventilator (not shown) with the patient 12, and includes the nebulizer 18 and the source of pressurized air 14. With the single limb breathing circuit 40, the patient tube 20 is again provided, fluidly connecting the patient 12 and the HME unit 16. A single tube 42 extends from the HME unit 16 opposite the patient 12, and is fluidly connected to the nebulizer 18 via the T-connector 28. The ventilator (not shown) is directly connected to the T-connector 28 via a tube 44. Where desired, the single limb breathing circuit 40 (as well as the dual limb breathing circuit 10 of FIG. 1) can be connected to a tracheostomy tube 46.

The present disclosure contemplates use of various types of nebulizers 18. With one example nebulizer 18, medication is provided which has been reconstituted with sterile water and placed in a reservoir provided in the nebulizer 18. Pressurized gas is provided to the nebulizer 18 that is blown across an atomizer within the nebulizer 18. The force of the gas over the atomizer pulls the medicated liquid from the medication reservoir up along the sides of the nebulizer 18 in a capillary action to provide a stream of the medicated liquid at the atomizer. When the medicated liquid hits the stream of forced air at the atomizer, the liquid is atomized into a multiplicity of small droplets. The force of the air propels this now nebulized mixture of air and medicated liquid into the breathing circuit 10, 40 and to the patient 12, where the medication is provided to the patient's lungs. Use of administration of medication in this procedure has been found to be highly effective in providing the medication through the lungs to the patient. Metered dose inhalers can also be used to provide medication in the air to the patient 12.

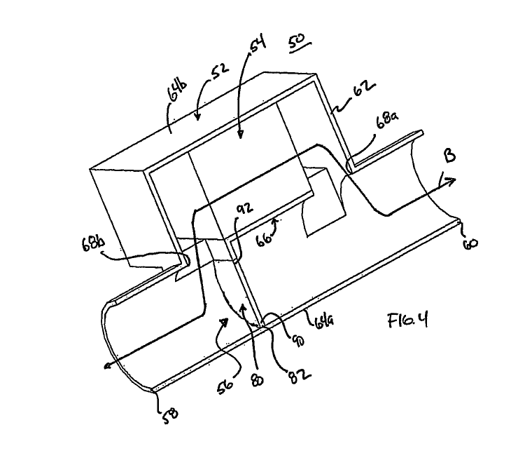

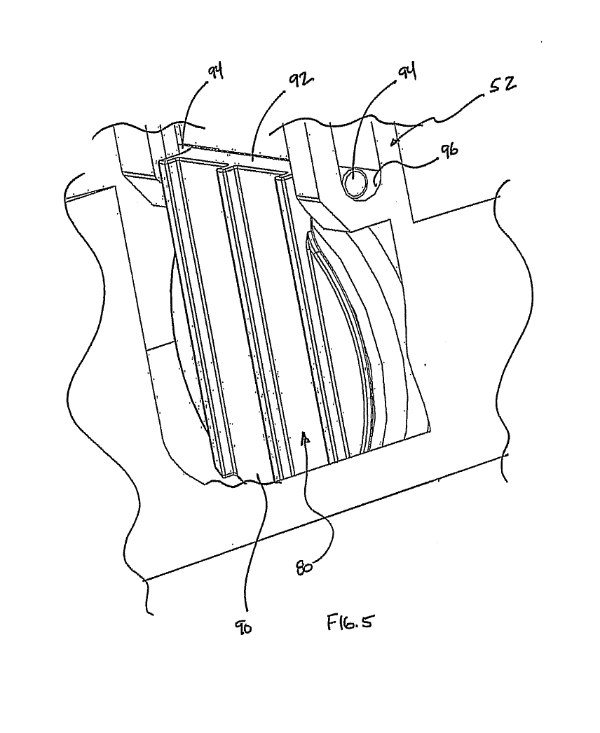

With the above general explanation of breathing circuits in mind, one configuration of an HME unit 50 useful as the HME unit 16 (FIGS. 1 and 2) is shown in simplified form in FIGS. 3 and 4. The HME unit 50 includes a housing 52, a heat and moisture media (HM media) 54, and a check valve assembly 56 (referenced generally). Details on the various components are provided below. In general terms, however, the housing 52 forms a first port 58, a second port 60, and an intermediate section 62. The HM media 54 is retained within the intermediate section 62. The housing 52 generally defines flow paths fluidly connecting the ports 58, 60, including a first flow path not intimately interfacing with the HM media 54 (e.g., to the side of the HM media 54, through a passage formed within, etc.), and a second flow path through and in contact with the material of the HM media 54. In this regard, the check valve assembly 56 is operable to dictate the path through which airflow will at least primarily occur.

The ports 58, 60 are generally illustrated in FIGS. 3 and 4. The ports 58, 60 can be constant diameter cylinders as shown, or can incorporate additional features/components known in the art for facilitating fluid connection to a corresponding ventilation circuit component (e.g., tubing, etc.). Similarly, the housing 52 can have a variety of exterior shapes differing from those reflected in FIGS. 3 and 4.

The housing 52 includes exterior wall segments 64a, 64b and at least one interior partition 66. The interior partition 66 is spaced from other components (e.g., the exterior wall segments 64a, 64b) to define first and second flow paths A (FIG. 3) and B (FIG. 4). For example, the interior partition 66 can partially establish passages 68a, 68b in establishing the second flow path B. Regardless, the HM media 54 is located along the second flow path B, whereas the first flow path A is apart from (e.g., around or to the side of) the HM media 54. Thus, the first flow path A constitutes a bypass pathway, and the second flow path A is an HME pathway.

As indicated above, the HM media 54 is sized and shaped for placement within the intermediate section 62. In this regard, the HM media 54 can assume a variety of forms known in the art that provide heat and moisture retention characteristics, and typically is or includes a foam material. Other configurations are also acceptable, such as paper or filter-type bodies. In more general terms, then, the HM media 54 can be any material capable of retaining heat and moisture regardless of whether such material is employed for other functions (e.g., filtering particle(s)). With the but one acceptable configuration of FIGS. 3 and 4, the HM media 54 is formed as a homogenous block of material, and does not include a discernable flow through passage. In other embodiments described below, the HM media can include one or more internal bypass passageways.

The check valve assembly 56 can assume a variety of forms capable of influencing which of the flow paths A or B airflow between the ports 58, 60 will at least primarily occur. For example, in some embodiments, the check valve assembly 56 includes an airflow obstruction member 80 positioned to selectively close an aperture 82 formed by the housing 52 along the first flow path A (e.g., between the interior partition 66 and the corresponding exterior wall segment 64a). In an opened or bypass position (FIG. 3) of the obstruction member 80, the obstruction member 80 is moved away from the aperture 82, such that the first flow path A is not obstructed by the obstruction member 80. In the opened or bypass position, the second flow path B is not fully obstructed by the obstruction member 80 such that airflow can occur along both of the flow paths A, B. However, the HM media 54 presents a resistance to airflow; because airflow will seek the path of least resistance, airflow between the ports 58, 60 will occur primarily along the first flow path A (with the obstruction member 80 in the opened position). Conversely, in a closed or HME position (FIG. 4) of the obstruction member 80, the obstruction member 80 encompasses or closes the aperture 82, thereby obstructing the first flow path A. Thus, in the closed position, airflow between the first and second ports 58, 60 occurs only along the second flow path B (and thus must pass through the HM media 54).

The obstruction member 80 can assume a variety of shapes, and is generally provided as a solid body (or bodies) through which airflow cannot pass. The obstruction member 80 can be rigid (e.g., thermoplastic) or elastic (e.g., silicone). In the one configuration of FIGS. 3 and 4, the obstruction member 80 is plate-like; alternatively, other check valve obstruction bodies (e.g., ball valve, sliding valve, duckbill valve, swing valve, lift check valve, diaphragm check valve, stop-check valve, etc.) are also acceptable. Regardless, the obstruction member 80 is transitionable between the first, opened position shown in FIG. 3 and the second, closed position shown in FIG. 4. For example, the obstruction member 80 can be akin to a plate, defined by a free end 90 opposite a pivot end 92. The pivot end 92 is pivotably mounted within the housing 52, for example, via arms 94 as shown in FIG. 5. The arms 94 extend from the pivot end 92 and are sized to be rotatably captured within retention slots 96, respectively, formed by the housing 52. That is to say, the arms 94 freely rotate or pivot within the corresponding slots 96. In some embodiments, a diameter of the arms 94 is significantly smaller (e.g., at least 10% smaller) than a diameter or width of the slots 96 to reduce friction. Further, a plane of the arms 96 is off-set relative to a plane of the obstruction member 80 (when provided as a plate or similar body) to encourage the obstruction member 80 to naturally assume the closed position (of FIG. 4).

Other transitionable assembly constructions are also acceptable, such as by providing the pivot end 92 as a living hinge. With these constructions, and returning to FIGS. 3 and 4, transitioning of the obstruction member 80 includes the obstruction member 80 pivoting at the pivot end 92, with the free end 90 traveling between the first and second positions. With this in mind, the free end 90 is configured to engage or seal against a corresponding structure of the housing 52, for example, the exterior wall segment 64a, in the second, closed position of FIG. 4. In other words, the obstruction member 80 is sized and shaped such that in the second position, the obstruction member 80 closes the first flow path A, thereby forcing or dictating that all airflow occur along the second flow path B as described above.

The check valve assembly 56 can be self-transitionable between the opened and closed positions in response to airflow to or through the HME unit 50 when the obstruction member 80 is allowed to freely pivot or rotate about the pivot end 92 (or other point of movement associated with the particular construction employed with the check valve assembly 56). As mentioned above, the check valve assembly 56 can be constructed such that the obstruction member 80 normally or naturally assumes the second or closed position of FIG. 4. Regardless, airflow to the HME unit 50 initiating at the second port 60 acts upon the obstruction member 80, forcing the obstruction member 80 to move or transition to the opened position of FIG. 3. Conversely, airflow to the HME unit initiating at the first port 58 forces the obstruction member 80 to move or transition to the closed position of FIG. 4.

In some embodiments, the check valve assembly 56 is further configured to selectively impede or prevent the obstruction member 80 from freely moving. In particular, the check valve assembly 56 includes additional components (not shown) that selectively act upon the obstruction member 80. With these constructions in mind, components of the check valve assembly 56 can operate such that in an HME mode of operation of the HME unit 50, the free end 90 is fixed or locked in the second position of FIG. 4. For example, the check valve assembly 56 can include a magnetic-type lock that when actuated (e.g., energized) operates to magnetically lock the obstruction member 80 (e.g., the obstruction member 80 is formed of a magnetic metal) in the second, closed position of FIG. 4; when the lock is not actuated, the obstruction member 80 freely moves in response to airflow as described above. Other selective locking techniques (e.g., mechanical, electromechanical, etc.) are also acceptable. Where provided, however, the locking device includes a component accessible by a user for dictating a mode of operation. More particularly, the check valve assembly 56 is operable by a user in a bypass mode or an HME mode.

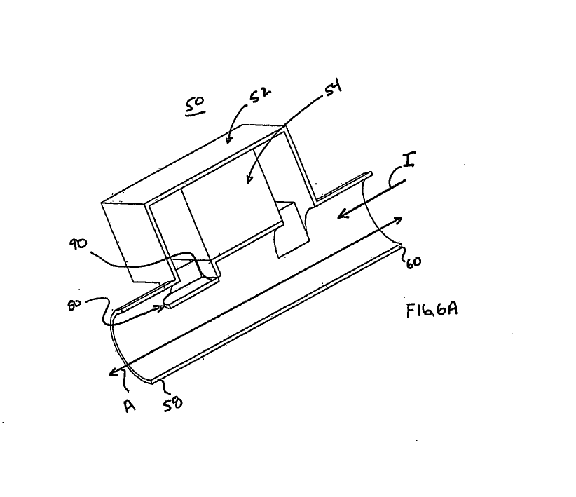

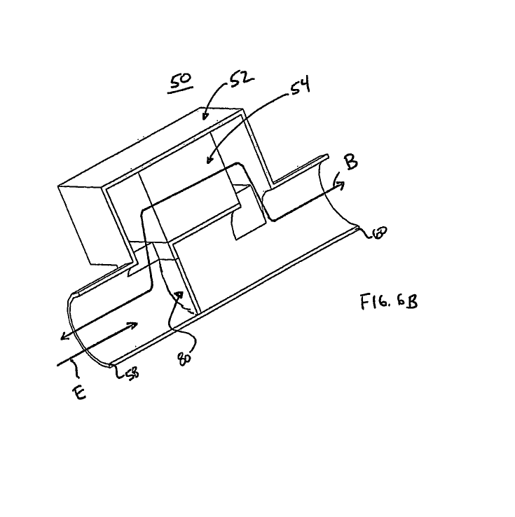

During use the HME unit 50 is fluidly connected to a patient breathing circuit, for example the breathing circuit 10 of FIG. 1 or the breathing circuit 40 of FIG. 2. The patient tube 20 is fluidly connected to the first port 58, and the second port 60 is fluidly connected to tubing connected to the ventilator (not shown). Thus, the first port 58 serves as a patient-side port, and the second port 60 serves as a ventilator-side port. In instances where the nebulizer 18 is operated to administer nebulized medication to the patient 12, the HME unit 50 is operated in the bypass mode that includes the obstruction member 80 freely moving in response to airflow. For example, and with reference to FIG. 6A, during an inspiratory phase of patient breathing (i.e., as the patient inhales), airflow to the HME unit 50 initiates at least primarily at the second or ventilator-side port 60 (arrow “I” in FIG. 6A). Because the obstruction member 80 is unconstrained (apart from the pivot end 90), the obstruction member 80 moves in response to the delivered air, transitioning to the opened position as illustrated. As a result, airflow from the ventilator-side port 60 to the patient-side port 58 occurs at least primarily along the first flow path A (it being recalled that while the second flow path B is not completely “closed,” the HM media 54 resists airflow such that minimal, if any, airflow will occur through the second flow path B). Thus, the possibility of the HM media 54 becoming clogged with mediation droplets being delivered to the patient is greatly minimized.

During an expiratory phase of patient breathing (i.e., as the patient exhales) in the bypass mode, airflow to the HME unit 50 initiates at least primarily at the first or patient-side port 58, as shown by the arrow “E” in FIG. 6B. In response to this exhaled air, the obstruction member 80 transitions to the closed position, thereby closing the first flow path A. As a result, as the patient exhales, airflow from the patient-side port 58 to the ventilator-side port 60 will occur along the second flow path B, and thus through the HM media 54. As point of reference, exhaled air from the patient will contain minimal, if any, amounts of medication droplets, such that clogging of the HM media 54 is of limited concern. However, by passing the exhaled air through the HM media 54, heat and moisture are introduced into the HM media 54 such that the HM media 54 is properly conditioned for subsequent treatment of airflow in the HME mode as described below.

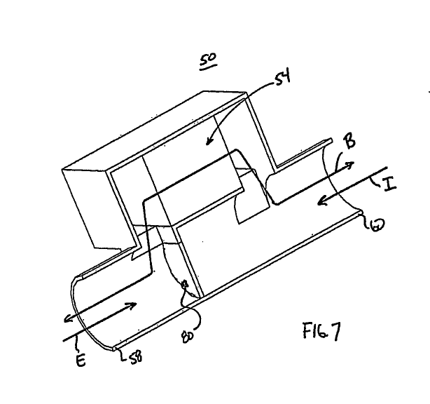

In instances where medication is not being provided to the patient 12 via the breathing circuit 10, 40 (i.e., the nebulizer 18 is either not connected to the breathing circuit 10, 40 and/or is non-operational), the HME unit 50 is operated in the HME mode in which the obstruction member 80 is “locked” in the closed position. With additional reference to FIG. 7, then, the obstruction member 80 does not move in response to the airflow initiating at either of the ports 58, 60, and instead remains locked in the closed position. Thus, airflow to and from the patient 12 via the HME unit 50 must pass through the HM media 54, with the HM media 54 absorbing moisture and heat from exhaled air, and then transferring moisture and heat to the inhaled air provided to the patient's lungs.

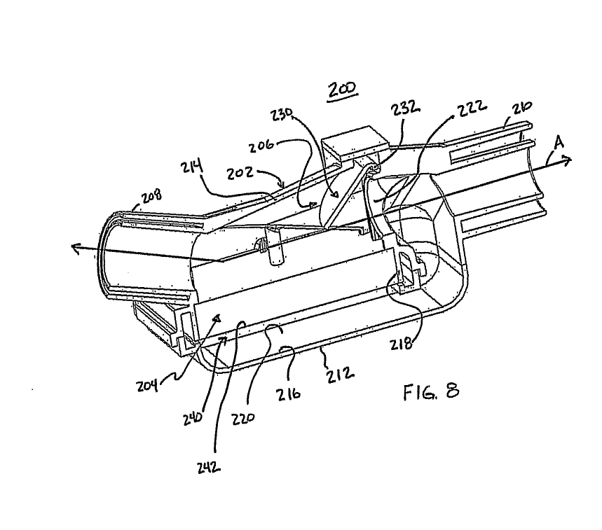

The HME unit 50 described above is but one acceptable configuration in accordance with principles of the present disclosure. Another embodiment HME unit 200 in accordance with the present disclosure and useful as the HME unit 16 (FIGS. 1 and 2) is partially illustrated in FIGS. 8 and 9. The HME unit 200 is akin to the HME unit 50 (FIGS. 3 and 4) described above, and includes a housing 202, an HM media 204, and a check valve assembly 206 (referenced generally). The housing 202 forms a first port 208 (e.g., a patient-side port), a second port 210 (e.g., ventilator-side port), and an intermediate section 212. The HM media 204 can assume any of the forms described above and is retained within the intermediate section 212, with the check valve assembly 206 operating to dictate a pathway through which airflow at least primarily progresses between the first and second ports 208, 210 as described below.

The housing 202, and in particular the intermediate section 212, includes opposing, upper and lower exterior wall segments 214, 216, as well as at least one interior partition 218. The interior partition 218 is spaced from the lower wall segment 216, thereby establishing a gap 220. Further, the interior partition 218 forms an aperture 222 adjacent the upper wall segment 214 with which the check valve assembly 206 is associated as described below. With this construction, then, the housing 202 defines first and second flow paths between the ports 208, 210, as designated by an arrow A in FIG. 8 and an arrow B in FIG. 9. The second flow path B includes the HM media 204, whereas the first flow path A does not. In other words, air flowing through the second flow path B interacts with the HM media 204, and thus constitutes an HME pathway. Conversely, air flowing in the first flow path A does not intimately interact with the HM media 204, and thus serves as a bypass pathway. As with previous embodiments, the first flow path/bypass pathway A is around the HM media 204 (e.g., to the side of, alternatively through an internal passageway defined by the HM media 204).

The check valve assembly 206 includes an obstruction member 230 as described above, for example a valve plate, which is movably assembled within the housing 202. The obstruction member 230 is sized and shaped to selectively encompass or close the aperture 222, with the check valve assembly 206 further including, in some embodiments, arm(s) 232 that movably (e.g., pivotably) associates the obstruction member 230 with the interior partition 218, and in particular the aperture 222. Thus, the obstruction member 230 is transitionable between a first or opened position (FIG. 8) and a second or closed position (FIG. 9). In the closed position, the obstruction member 230 nests against the interior partition 218, thereby closing the aperture 222 and thus the first flow path B. In other words, in the closed position, only the second flow path B is “open” between the first and second ports 208, 210, thereby dictating that airflow through the HME unit 200 must interface with the HM media 204. Conversely, in the first, opened position, the obstruction member 230 is spaced from the interior partition 218, such that airflow can occur through the aperture 222. Thus, in the opened position, the first flow path A is open, allowing airflow directly between the first and second ports 208, 210 apart from, or around, the HM media 204.

The check valve assembly 206 positions the obstruction member 230 to move, in the absence of any other constraints such as a locking device (as described below), in a predetermined fashion in response to the direction of airflow through the HME unit 200. More particularly, the obstruction member 230 is located relative to the aperture 222 so as to freely pivot to the opened position of FIG. 8 in response to airflow initiating at the second port 210. In response to airflow initiating at the first port 208, the obstruction member 230 self-transitions to the closed position of FIG. 9.

Though not shown, the check valve assembly 206 can include one or more additional features allowing a user to selectively “lock” the obstruction member 230 in the closed position. For example, a magnetic locking device can be provided. Alternatively, any other mechanism (mechanical, pneumatic, and/or electrical in nature) can be employed. Regardless, in a bypass mode of operation, the obstruction member 230 is released, and freely moves relative to the aperture 222 (in response to a direction of airflow through the HME unit 200 as described above) between the opened and closed positions. In an HME mode, the obstruction member 230 is locked in the closed position, forcing airflow to occur along the second flow path B, regardless of flow direction entering the housing 202.

As with the above embodiments, the first port 208 can be connected to a patient interface (e.g., breathing tube, endotracheal tube, etc.), and thus serves as a patient-side port; the second port 210 can be connected to tubing establishing a fluid connection to the ventilator and thus serves as a ventilator-side port. In instances where the breathing circuit (FIGS. 1 and 2) to which the HME unit 200 is assembled is not providing aerosolized medication, the HME unit 200 is operated in the HME mode whereby the obstruction member 230 is locked in the closed position (FIG. 9), closing the first flow path A. Thus, airflow through the HME unit 200 (between the ports 208, 210) interacts with the HM media 204, with the HME unit 200 serving as a typical HME unit with the HM media 204 absorbing moisture and heat from patient exhaled air, and transferring the moisture and heat to the inhaled air provided to the patient. This HME pathway-only arrangement in the HME mode remains intact regardless of flow direction to the housing 202.

Where the breathing circuit to which the HME unit 200 is fluidly connected is operating to provide nebulized medication to the patient, the HME unit 200 is transitioned to the bypass mode in which the obstruction member 230 is freely movable relative to the interior partition 218/aperture 222. During the inspiratory phase, airflow within the HME unit 200 primarily initiates at the ventilator-side port 210, forcing the obstruction member 230 to move to the opened position of FIG. 8. While the second flow path B remains “open” in the opened position of the obstruction member 230, a vast majority of airflow through the HME unit 200 will occur along the second flow path B. More particularly, and as described above, the HM media 204 presents a resistance to airflow; because airflow will seek the path of least resistance, in the opened position, a vast majority of the airflow from the ventilator-side port 210 to the patient-side port 208 will occur directly along the first flow path A. As described above, entrained medication droplets are thus highly unlikely to intimately interact with the HM media 204 in a deleterious manner. Conversely, as exhaled air enters the HME unit 200 at the patient-side port 208 (i.e., during the expiratory phase), the airflow acts upon the obstruction member 230, causing the obstruction member 230 to transition to the closed position (FIG. 9) to close the first flow path A. Thus, in the bypass mode, the patient-exhaled air passes along the second flow path B, such that contained heat and moisture conditions the HM media 204 as desired.

Though not shown, the HME unit 200 can incorporate one or more of the additional, optional features described above. For example, the HME unit 200 can include a secondary filter 240. The secondary filter 240 can assume a variety of forms (e.g., HMEF as known in the art), and is assembled directly adjacent the HM media 204. With the one construction of FIGS. 8 and 9, the secondary filter 240 abuts a major surface 242 of the HM media 204, and thus can have a relatively large filtration surface area commensurate with a surface area of the HM media 204. Further, the bypass features of the HME unit 200 described above with respect to the HM media 204 are equally applicable relative to the secondary filter 240. Thus, the secondary filter 2400 can be bypassed in the identical manner as the HM media 204. As compared to previous HME devices that either do not include a secondary filter or provide the filter apart from the HM media bypass features, the secondary filter 240 in accordance with the present disclosure can be relatively large, enabling lower resistance and higher filtration efficiency. The secondary filter 240 is an optional component in accordance with the present disclosure, and it will be understood that the HM media 204 can provide desired filtering in and of itself.

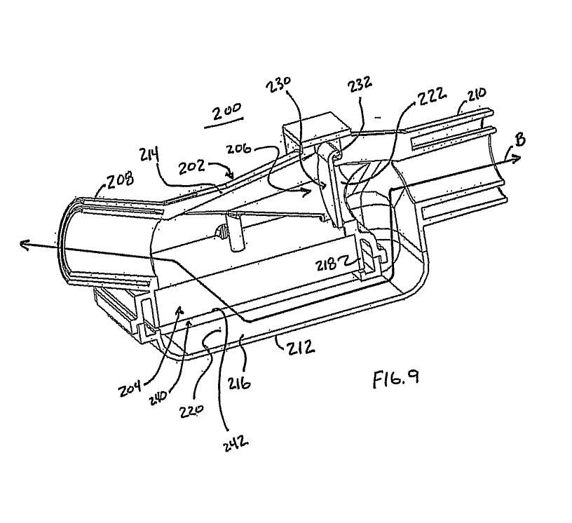

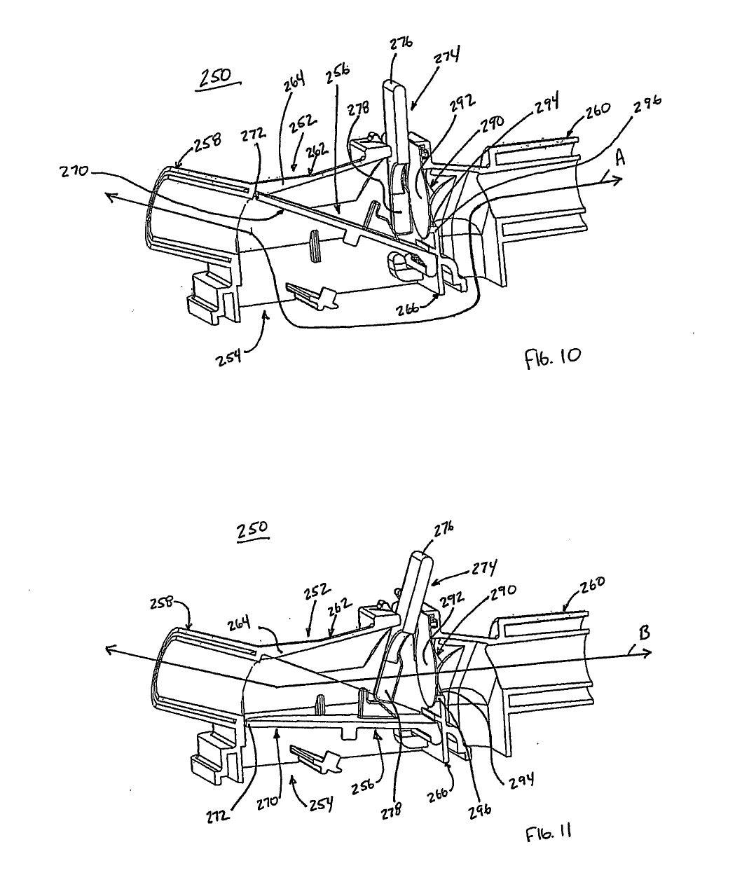

Yet another embodiment HME unit 250 in accordance with principles of the present disclosure and useful as the HME unit 16 (FIGS. 1 and 2) is partially shown in FIGS. 10 and 11. The HME unit 250 includes a housing 252, an HM media 254 (omitted from the views, but a location relative to the housing 252 referenced generally), a primary valve mechanism 256, and a check valve assembly 257 (referenced generally). The housing 252 forms first and second ports 258, 260 extending from opposite sides of an intermediate section 262. The HM media 254 is disposed within the intermediate section 262, with the primary valve mechanism 256 and the check valve assembly 257 dictating a pathway through which airflow between the ports 258, 260 is at least primarily directed.

The housing 252 includes exterior wall segments 264, and at least one interior partition 266. The interior partition 266 is spaced from the exterior wall segments 264, thereby defining a first flow path A (FIG. 10) and a second flow path B (FIG. 11). As with previous embodiments, the second flow path B includes the HM media 254, whereas the first flow path A does not. Thus, the first flow path A is a bypass pathway, and the second flow path B is an HME pathway. As with other embodiments, the first flow path/bypass pathway A is around (e.g., to the side of) the HM media 254.

Unlike previous embodiments, the primary valve mechanism 256 operates in combination with the check valve assembly 257 in dictating a primary flow path through the HME unit 250. That is to say, the primary valve mechanism 256 and the check valve assembly 257 are provided as discrete components, each affecting airflow as described below. In general terms, however, the check valve assembly 257 is akin to the check valve assemblies described in previous embodiments.

The primary valve mechanism 256 includes a valve member (e.g., a valve plate, ball, etc.) 270 movably assembled within the housing 252 and configured to selectively close the first flow path A. More particularly, in a second or HME position (FIG. 11) of the valve member 270, a leading end 272 of the valve member 270 contacts the exterior wall segment 264, thereby “closing” the first flow path A relative to the first and second ports 258, 260. Thus, in the HME position, the valve member 270 directs all airflow between the ports 258, 260 to occur only along the second flow path B.

Conversely, in a first or bypass position (FIG. 10) of the valve member 270, the leading end 272 is transitioned away from the exterior wall segment 264, thereby opening (relative to the valve member 270) the first flow path A. In the bypass position, the valve member 270 does not, in some embodiments, effectuate complete closure of the second flow path B, such that in a bypass mode of the HME unit 250, airflow through the HM media 254 can occur. However, and as previously described, the HM media 254 presents a resistance to airflow, such that in the bypass mode, airflow will seek the path of least resistance and thus primarily occur along the first flow path A.

Transitioning of the valve member 270 by a user between the first and second positions can be facilitated in a number of manners. With some constructions, the primary valve mechanism 256 includes a biasing device (not shown), such as a spring, that biases the valve member 270 to the second or HME position (FIG. 11). An actuator arm 274 is pivotably assembled to the housing 252, and defines first and second ends 276, 278. The first end 276 extends exteriorly from the housing 252, whereas the second end 278 bears against the valve member 270. With this but one acceptable construction, then, the valve member 270 can be transitioned by a user from the HME position (FIG. 11) to the bypass position (FIG. 10) by applying a rotational or moment force onto the first end 276. Rotation of the actuator arm 274, in turn, causes the second end 278 to bear against and cause movement of the valve member 270 in a cam-like fashion. Rotation of the actuator arm 274 in an opposite direction removes the force applied by the actuator arm 274, thus allowing the biasing device to force the valve member 270 back to the HME position. Alternatively, a wide variety of other components can be employed to allow a user to select the desired position or mode of operation.

The check valve assembly 257 is provided apart from the primary valve mechanism 256 and includes an obstruction member 292. The obstruction member 292 is assembled within the housing 252 so as to selectively close the first flow path A.

For example, with some constructions, the housing 252 forms an aperture 294 located between the first and second ports 258, 260 along the first flow path A, and defined by a perimeter 296. The obstruction member 292 (e.g., a valve plate) is sized and shaped in accordance with a size and shape of the aperture 294, such that when positioned against the perimeter 296, the obstruction member 292 closes the aperture 294 (i.e., the closed position of FIG. 10). In this regard, the obstruction member 292 is positioned and assembled so as to freely move away (in the absence of other constraints described below) from the aperture 294 in the presence of gas flow in a first direction along the flow path A (i.e., the opened position of FIG. 11), and close against the aperture 294 in the presence of gas flow in an opposite flow direction. For example, and with specific reference to FIG. 10, gas flow in a flow direction from the second port 260 to the first port 258 causes the obstruction member 292 to pivot away from the aperture 294, thereby permitting gas flow along the first flow path A to freely occur. Conversely, gas flow along the first flow path A in a flow direction from the first port 258 to the second port 260 forces the obstruction member 292 into engagement with the perimeter 296, thereby closing the aperture 294. Thus, even with the valve member 270 in the bypass position of FIG. 10, the obstruction member 292 periodically closes the first flow path A (i.e., only in the presence of gas flow from the first port 258 to the second port 260), such that gas flow occurs in this direction only along the second flow path B.

The check valve assembly 257 is further configured to provide for selective locking of the obstruction member 292 in the closed position. For example, the actuator arm 274 is positioned to selectively interface with the obstruction member 292. More particularly, in the orientation of FIG. 11, the actuator arm 274 bears against the obstruction member 292, locking the obstruction member 292 in the closed position. Thus, the HME mode of the primary valve mechanism 256 directly corresponds with the closed position of the obstruction member 292. In the orientation of FIG. 10, the actuator arm 274 is maneuvered away from engagement with the obstruction member 292 such that the obstruction member 292 is free to move as described above. In other words, in the bypass mode of operation, the obstruction member 292 freely pivots (or otherwise moves) between the opened and closed positions in response to gas flow directed through the HME unit 250.

The check valve assembly 257 described above can, in some embodiments, enhance performance of the HME unit 250. For example, during use, the HME unit 250 can be assembled to the patient breathing circuit (not shown), such that the first port 258 serves as a patient-side port, whereas the second port 260 serves as a ventilator-side port. With these designations in mind, and with the HME unit 250 in the bypass mode (i.e., as in FIG. 10 with the valve member 270 forced and retained in the bypass position, and the obstruction member 292 not constrained from free movement), medication droplet-entrained gas flow from the ventilator-side port 260 to the patient-side port 258 occurs primarily along the first flow path A. That is to say, the valve member 270 and the obstruction member 292 do not obstruct airflow from the ventilator-side port 260 to the patient-side port 258. As such, with patient inhalation, the medication droplets are delivered to the patient's lungs and do not overtly contact the HM media 254. With patient exhalation, however, the gas flow direction changes (i.e., travels from the patient-side port 258 to the ventilator-side port 260), thus causing the obstruction member 292 to close the aperture 294 as described above. The exhaled air is thus forced to progress through the HM media 254 at which heat and moisture is captured and retained. Because the exhaled air from the patient includes minimal, if any, medication droplets, any clogging concerns of the HM media 254 are greatly minimized.

In the HME mode of operation of the HME unit 250, the valve member 270 is forced and retained in the HME position, and the obstruction member 292 is locked in the closed position as shown in FIG. 11. Thus, regardless of airflow direction through the HME unit 250, all gas flow is directed through the HM media 254, where heat and moisture are retained by, and delivered to, air flowing through the HME unit 250.

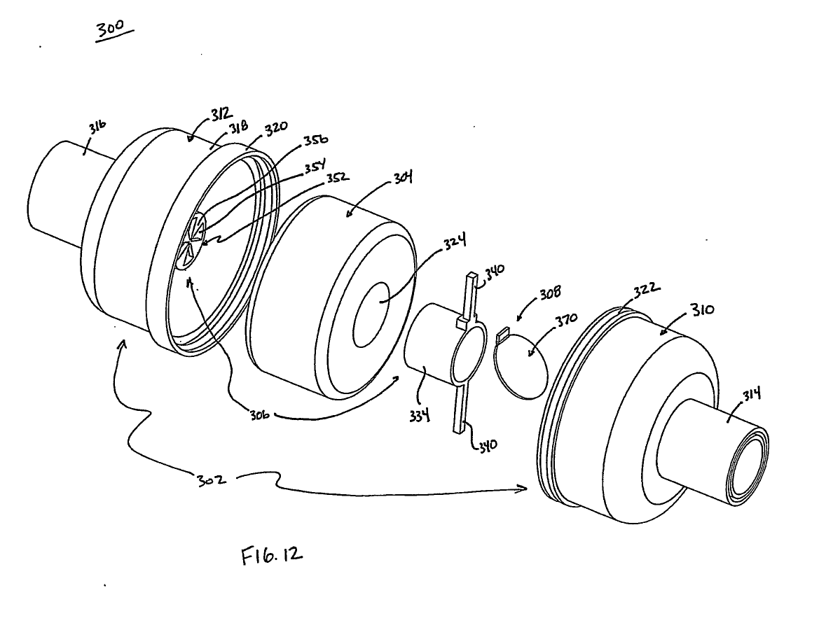

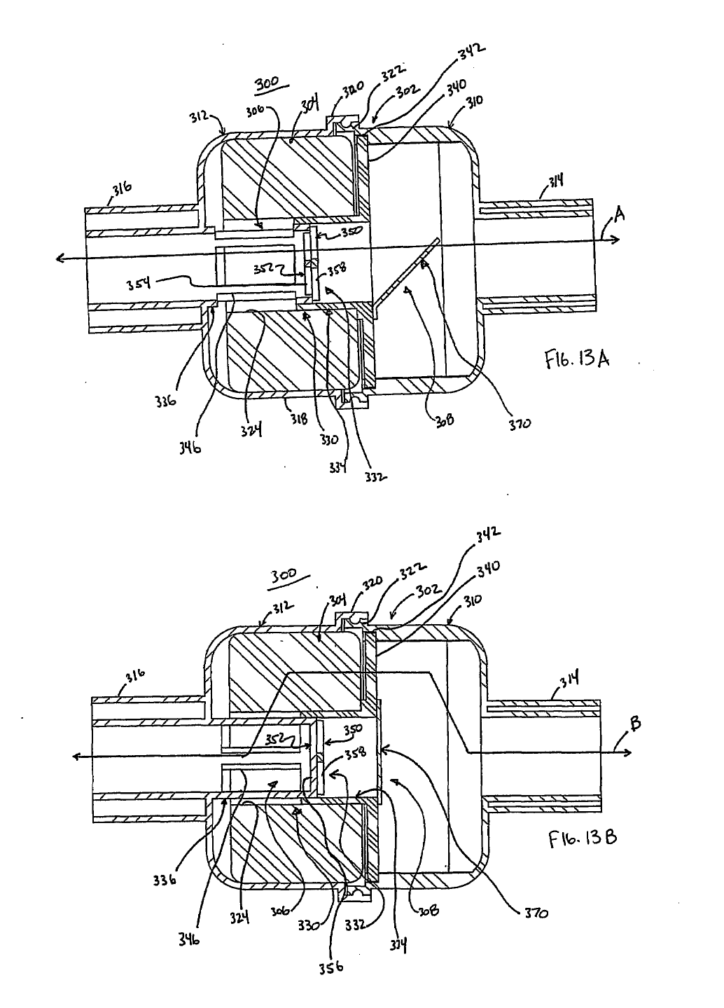

The primary valve mechanism 256 described above is but one example useful with the HME unit/check valve assembly configuration of the present disclosure. In other words, the primary valve mechanism, where employed, can assume a variety of other forms. For example, FIG. 12 illustrates another embodiment HME unit 300 in accordance with aspects of the present disclosure and useful as the HME unit 16 (FIGS. 1 and 2). The HME unit 300 includes a housing 302, an HM media 304, a primary valve mechanism 306 (referenced generally), and a check valve assembly 308. The housing 302 includes housing halves 310, 312 that combine, upon final assembly, to define first and second ports 314, 316, and an intermediate section 318 extending there between. The HM media 304 is retained within the intermediate section 318, with the primary valve mechanism 306 and the check valve assembly 308 operating to dictate a flow path along which gas flow between the ports 314, 316will at least primarily occur. In particular, and as with previous embodiments, the HME unit 300 provides a bypass path in which direct, intimate contact with the HM media 304 is substantially avoided (arrow “A” in FIG. 13A), and an HME path in which gas flow is forced into direct contact with the HM media 304 (arrow “B” in FIG. 13B).

The housing halves 310, 312 are configured to be rotatably assembled to one another. For example, the second half 312 includes a flange 320 configured to slidably capture a rim 322 formed by the first half 310. Assembly of the housings 310, 312 is reflected in FIGS. 13A and 13B. As described below, this rotatable relationship effectuates arrangement of the primary valve mechanism 306 in a desired mode.

The HM media 304 can be formed of any of the materials identified in previous embodiments. With the construction of FIGS. 12-13B, however, the HM media 304 forms an internal passage 324, such that the HM media 304 has a ring-like shape. The internal passage 324 is sized to receive at least a portion of the primary valve mechanism 306 as described below.

With referenced to FIGS. 12-13B, the primary valve mechanism 306 includes a conduit assembly 330 and a valve member assembly 332. The conduit assembly 330 and the valve member assembly 332 combine to form (or “complete”) the bypass path A or the HME path B as described below.

The conduit assembly 330 includes, in some embodiments, a first conduit 334 and a second conduit 336. The first conduit 334 is assembled to, or alternatively integrally formed by, the first housing half 310. For example, in some embodiments, one or more splines 340 extend radially from the first conduit 334, and are configured for mounting to a corresponding feature of the first housing half 310. For example, and as best shown in FIGS. 13A and 13B, the first housing half 310 can form a shoulder 342 to which the spline(s) 340 is mounted (e.g., friction fit, weld, adhesive bonding, etc.). Regardless, the first conduit 334 is spatially affixed relative to the first housing half 310, and is fluidly open (depending upon a position of the check valve assembly 308 as described below) to the first port 314

The second conduit 336 is integrally formed by, or assembled to, the second housing half 312 as best shown in FIGS. 13A and 13B. Thus, the second conduit 336 is spatially affixed to the second housing half 312, and thus rotates relative to the first housing half 310 with rotation of the second housing half 312 relative to the first housing half 310 (and vice-versa). The second conduit 336 is fluidly connected to the second port 316, and forms one or more side channels 346. The side channels 346 are fluidly open to an interior of the second conduit 336, and thus provide a pathway for gas flow to and from the second conduit 336.

The valve member assembly 332 includes, in some embodiments, a first valve member 350 (shown partially in FIGS. 13A and 13B) and a second valve member 352. The valve members 350, 352 are in many respects identical such that following description of the second valve member 352 shown in FIG. 12 is generally applicable to the first valve member 350. The second valve member 352 is integrally formed by, or assembled to, the second conduit 336, extending radially across the second conduit 336. Further, the second valve member 352 forms one or more thru holes 354. The thru holes 354 extend through a thickness of valve member 352, and are circumferentially separated by wall segments 356, as best illustrated in FIG. 12. The first valve member 350 has a similar construction and is integrally formed by, or assembled to, the first conduit 334. Though hidden in the view of FIG. 12, the first valve member 350 forms thru holes 358 that are circumferentially separated by wall segments as generally reflected in FIGS. 13A and 13B, with the corresponding wall segments being akin to the wall segments 356 of the second valve member 352 as described above.

Upon final assembly of the primary valve mechanism 306, the first and second conduits 314, 316 are coaxially aligned, with the valve members 350, 352 abutting one another. In the bypass orientation of the primary valve mechanism 306 (FIG. 13A), the valve members 350, 352 are arranged such that the corresponding thru holes 354, 358 are aligned. As a result, gas flow between the conduits 334, 336 can occur via the thru holes 354, 358. Conversely, in an HME arrangement of the primary valve mechanism 306 (FIG. 13B), the valve members 350, 352 are arranged such that the wall segments (not shown) of the first valve member 350 “cover” the thru holes 354 of the second valve member 352. Similarly, the wall segments 356 of the second valve member 352 “cover” the thru holes 358 of the first valve member 350. As a result, gas flow between the conduits 334, 336 is obstructed. Instead, gas flow is forced to occur along the HME path B, passing through the side channels 346 of the second conduit 336. As a point of reference, in the cross-sectional view of FIG. 13B, the splines 340 are illustrated. While gas flow “through” these splines 340 may not occur, the splines 340 have a relatively small width, such that the HME path B exists “around” the splines 340.

With the above configuration, in an HME mode (FIG. 13B), the second valve member 352 is rotationally positioned relative to the first valve member 350 (i.e., the second housing half 312 is rotated relative to the first housing half 310 and/or vice-versa) such that the corresponding thru holes 354, 358 are not aligned. Gas flow through the conduit assembly 330/internal passages(s) 314 of the HM media 304 is thus “blocked” and cannot occur. Instead, gas flow is forced through a thickness of the HM media 304 (flow path B) via the side channels 346. When second valve member 352 is rotated such that the thru holes 354, 358 are aligned (e.g., transition from FIG. 13B to FIG. 13A), the conduit assembly 330/internal passage 324 in the HM media 304 are opened, allowing gas flow to at least primarily occur “through” the conduit assembly 330 with minimal intimate contact with the HM media 304 itself.

The check valve assembly 308 is provided apart from the primary valve mechanism 306 and includes an obstruction member 370. The obstruction member 330 is assembled within the housing 302 so as to selectively close the bypass flow path A.

For example, with some constructions, the obstruction member 370 is arranged proximate the first conduit 334, opposite the first valve member 350. The obstruction member 370 (e.g., a valve plate) is sized and shaped in accordance with a size and shape of the first conduit 334, such that when positioned against the first conduit 334, the obstruction member 370 closes the first conduit 334 (i.e., moves to the closed position of FIG. 13B). In this regard, the obstruction member 370 is positioned and assembled so as to freely move away (in the absence of other constraints described below) from the passage in the presence of gas flow in a first direction of flow along the flow path A (i.e., the opened position of FIG. 13A), and close against the first conduit 334 in the presence of gas flow in an opposite flow direction. For example, and with specific reference to FIG. 13A, gas flow in a flow direction from the second port 316 to the first port 314 causes the obstruction member 370 to pivot away from the first conduit 334, thereby permitting gas flow along the first flow path A to freely occur. Conversely, gas flow along the first flow path A in a flow direction from the first port 314 to the second port 316 forces the obstruction member 370 into engagement with the first conduit 334, thereby closing the conduit assembly 330. Thus, even with the primary valve mechanism 306 in the bypass position of FIG. 13A, the obstruction member 370 periodically closes the bypass flow path A (i.e., only in the presence of gas flow from the first port 314 to the second port 316), such that gas flow in this direction occurs only along the HME flow path B.

The check valve assembly 308 can further be configured to provide for selective locking of the obstruction member 370 in the closed position. For example, the check valve assembly 308 can include the magnetic locking device described above, or any other components able to provide selective locking of the obstruction member 370 in the closed position of FIG. 13B.

The check valve assembly 308 described above can, in some embodiments, enhance performance of the HME unit 300. For example, during use, the HME unit 300 can be assembled to the patient breathing circuit (not shown), such that the first port 314 serves as a patient-side port, whereas the second port 316 serves as a ventilator-side port. With these designations in mind, and with the HME unit 300 in the bypass mode (i.e., as in FIG. 13A with the valve members 350, 352 arranged such that the through holes 354, 358 are aligned and the obstruction member 370 not constrained from free movement), medication droplet-entrained airflow from the ventilator-side port 316 to the patient-side port 314 occurs primarily along the bypass flow path A. That is to say, the valve members 350, 352 and the obstruction member 314 do not obstruct gas flow from the ventilator-side port 316 to the patient-side port 314. As such, with patient inhalation, the medication droplets are delivered to the patient's lungs and do not overtly contact the HM media 304. With patient exhalation, however, the gas flow direction changes (i.e., travels from the patient-side port 314 to the ventilator-side port 316), thus causing the obstruction member 370 to close the conduit assembly 330 as described above. The exhaled air is thus forced to progress through the HM media 304 at which heat and moisture is captured and retained. Because the exhaled air from the patient includes minimal, if any, medication droplets, any clogging concerns of the HM media 304 are minimal.

In the HME mode of operation of the HME unit 300, the valve members 350, 352 are arranged in the HME position and the obstruction member 370 is locked in the closed position as shown in FIG. 13B. Thus, regardless of gas flow direction through the HME unit 300, all gas flow is directed through the HM media 304, where heat and moisture are retained by, and delivered to, gas flowing through the HME unit 300.

Regardless of an exact design, the HME unit of the present disclosure provides a marked improvement over previous designs. The HME unit provides viable HME and bypass operational modes. However, unlike conventional bypass-type HME unit designs, the HME unit of the present disclosure is compact and streamlined, and user transitioning between the HME and bypass modes is easily accomplished. Further, by incorporate a check valve, the bypass mode of operation facilitates minimal interaction of aerosolized gas flow with the HM media during patient inhale, while encouraging desired gas flow interface with the HM media during patient exhale.

Although the present disclosure has been described with reference to preferred embodiments, workers skilled in the art will recognize that changes can be made in form and detail without departing from the spirit and scope of the present disclosure.

What is claimed is:

1. A heat and moisture exchange (HME) unit comprising:
a housing forming a first port, a second port, and an intermediate section extending between the first and second ports, the intermediate section defining first and second flow paths fluidly connecting the first and second ports;
a heat and moisture retaining media (HM media) maintained within the intermediate section along the second flow path; and
a check valve assembly including an obstruction member movably positioned within the intermediate section to selectively open the first flow path in an opened position and close the first flow path in a closed position;
wherein the HME unit is configured to provide a first mode of operation in which the obstruction member transitions to the opened position in response to gas flow in a flow direction from the second port toward the first port, and transitions to the closed position in response to gas flow in a flow direction from the first port toward the second port.

2. The HME unit of claim 1, wherein the HME unit is further configured to provide a second mode of operation in which the obstruction member is locked in the closed position to close the first flow path.

3. The HME unit of claim 2, wherein the first mode of operation is a bypass mode and the second mode of operation is an HME mode.

4. The HME unit of claim 2, wherein the check valve assembly further includes a locking device for selectively locking the obstruction member in the closed position.

5. The HME unit of claim 1, wherein the obstruction member is a valve plate.

6. The HME unit of claim 5, wherein the valve plate is pivotably mounted within the intermediate section.

7. The HME unit of claim 6, wherein the valve assembly further includes a wall forming an aperture having a size less than a size of the valve plate, and further wherein the valve plate is mounted adjacent the aperture for closing the aperture in the closed position.

8. The HME unit of claim 7, wherein the aperture defines a portion of the first flow path.

9. The HME unit of claim 8, wherein the valve plate is positioned within the first flow path.

10. The HME unit of claim 1, further comprising:
a primary valve mechanism apart from the check valve assembly, the primary valve mechanism configured to selectively open and close at least one of the first and second flow paths.

11. The HME unit of claim 10, wherein the primary valve mechanism includes a valve member movably positioned relative to the first flow path.

12. The HME unit of claim 11, wherein the primary valve mechanism is configured to maintain the valve member in an HME position and a bypass position as selected by a user, the HME position including the valve member not obstructing the second flow path and obstructing the first flow path, and the bypass position including the valve member not obstructing the first flow path.

13. The HME unit of claim 10, wherein the primary valve mechanism includes a first valve member rotatably maintained relative to a second valve member.

14. A method of providing respiratory assistance to a patient, the method comprising:
providing an HME unit including:
a housing forming a ventilator-side port, a patient-side port, and an intermediate section extending between the ports, the intermediate section defining first and second flow paths fluidly connecting the ports,
a heat and moisturizing retaining media (HM media) maintained within the intermediate section along the second flow path,
a check valve assembly including an obstruction member movably positioned within the intermediate section;
connecting the ventilator-side port to a source of pressurized gas;
connecting the patient-side port to a patient;
operating the source of pressurized gas to deliver airflow to the HME unit; and
operating the HME unit in a first, bypass mode in which:
gas flow entering the HME unit at the ventilator-side port causes the obstruction member to open the first flow path,
gas flow entering the HME unit at the patient-side port causes the obstruction member to close the first flow path.

15. The method of claim 14, further comprising:
operating the HME unit in a second, HME mode in which the obstruction member prevents gas flow entering the HME unit at the patient-side port from passing through the first flow path.

16. The method of claim 15, wherein operating the HME unit in the second HME mode further includes:
locking the obstruction member in the closed position to close the first path.

17. The method of claim 14, wherein the HME unit further includes a primary valve mechanism including a valve member operable to selectively close at least one of the first and second flow paths, and further wherein operating the HME unit in the first, bypass mode includes:
arranging the valve member such that the valve member does not close the first flow path.

18. The method of claim 17, wherein operating the HME unit in the first, bypass mode further includes:
arranging the valve member to close the second flow path.

19. The method of claim 17, further comprising:
operating the HME unit in a second, HME mode including:
arranging the valve member such that the valve member does not obstruct the second flow path.

20. The method of claim 19, wherein operating the HME unit in the second, HME mode further includes:
arranging the valve member to close the first flow path.

21. The method of claim 17, wherein arranging the valve member includes pivoting the valve member relative to the housing.

22. The method of claim 17, wherein arranging the valve member includes rotating the valve member.
